(19) United States
(12) Patent Application Publication
(10) Pub. No.: US 2014/0153423 A1
(43) Pub. Date: Jun. 5, 2014

(54) METHOD FOR HANDOVER OF TERMINAL USING MULTI-CONNECTION IN CELLULAR COMMUNICATION SYSTEM

(71) Applicant: Electronics and Telecommunications Research Institute, Daejeon (KR)

(72) Inventors: Jae Sheung SHIN, Daejeon (KR); Sook Yang KANG, Daejeon (KR); Eun Ah KIM, Daejeon (KR); Hyun Seo PARK, Daejeon (KR); Sung Min OH, Daejeon (KR); Ae Soon PARK, Daejeon (KR); Pyeong Jung SONG, Daejeon (KR)

(73) Assignee: Electronics and Telecommunications Research Institute, Daejeon (KR)

(21) Appl. No.: 13/974,951

(22) Filed: Aug. 23, 2013

(30) Foreign Application Priority Data
Dec. 5, 2012 (KR) 10-2012-0140121

(51) Int. Cl. H04W 36/30

(52) U.S. Cl. CPC H04W 36/30
USPC 370/252

(57) ABSTRACT

A method for handover of a terminal using a multi-connection in a cellular communication system is disclosed. The method for handover according to the present invention includes a multi-connection setting procedure of setting a connection to a second base station in addition to a connection to a first base station according to movement of a terminal in a direction from the first base station to the second base station, and a connection release procedure of releasing the connection to the first base station. Specifically, the present invention may be applied in a multi-beam management environment of super high frequency (SHF) and extremely high frequency (EHF) bandwidths, and may obtain an effect of decreasing signaling overhead and process latency of a conventional handover method.

### CLAIM FOR PRIORITY

This application claims priority to Korean Patent Application No. 2012-0140121 filed on Dec. 5, 2012 in the Korean Intellectual Property Office (KIPO), the entire contents of which are hereby incorporated by reference.

### BACKGROUND

1. Technical Field

The present invention relates to a method for handover of a terminal in a cellular communication system, and more specifically to a method for handover of terminal that may be applied to a cellular communication system managing multiple beams in a high frequency bandwidth such as a super high frequency (SHF) or an extremely high frequency (EHF).

2. Related Art

Mobile data is expected to increase to 1000 times its current amount in the next ten years, and in order to accommodate this, various technologies for increasing capacity of a cellular communication network are being studied. Among them, a wireless transmission technology using a frequency of an SHF (generally 3 to 30 GHz)/EHF (generally 30 to 300 GHz) bandwidth capable of obtaining unused bandwidth equal to or greater than 1 GHz and increasing frequency efficiency is expected to be used.

When a cellular communication system is operated based on beamforming in the SHF/EHF bandwidth, a terminal may receive a control signal and data independently transferred through many beams, and thus data capacity may be greatly increased.

However, transmission of the SHF/EHF bandwidths, unlike transmission using a conventional cellular bandwidth, has a constraint that a line of sight (LOS) should be ensured between transmission and reception devices when transmission is performed. This constraint indicates that a terminal should be located in an LOS area of a base station transmission beam so that the base station can communicate with the terminal

However, in the case of a downtown area or a suburban area, even with a macro base station, various obstacles such as buildings etc. may be present, and therefore it is difficult to ensure that all peripheral terminals are in the LOS area of the macro base station transmission beam.

Thus, in order to minimize a coverage hole of a base station having the LOS constraint, an environment in which many wireless repeaters relaying a signal transmitted through a base station beam are installed singly or multiply is applied. A new method for handover of a terminal considering this multi-beam environment is needed.

### SUMMARY

An object of the present invention is to provide a method for handover of a terminal in which, when a terminal enters a beam area of a new base station with which data reception is possible while the terminal moves, the terminal additionally accesses the new base station and maintains a multi-connection in order to resolve latency of a handover process and a signaling load.

Specifically, an object of the present invention is to provide a method for handover of a terminal suitable for a cellular communication system managing multiple beams based on beamforming in an SHF/EHF bandwidth.

A method for handover of a terminal in a multi-beam environment according to one aspect of the present invention for achieving the above-mentioned object may include (a) measuring quality of a beam received from a second base station by a terminal receiving service of a first base station, (b) when the quality of the beam received from the second base station is equal to or greater than a predetermined critical value, performing random access to the second base station, (c) when the random access to the second base station is successful, setting a connection to the second base station in addition to a connection to the first base station and (e) transmitting/receiving data with the first terminal and the second terminal

Here, at least one of the first base station and the second base station may be a relay base station.

Here, the multi-beam environment may be operated in a super high frequency (SHF)Λextremely high frequency (EHF) bandwidth.

Here, in operation (c), the setting of the connection to the second base station may be processed at the lowest branch node to which the first base station and the second base station are both connected. At this time, when the first base station and the second base station are relay base stations connected to the same macro base station, the lowest branch node may be the macro base station, and when the first base station and the second base station are macro base stations, the lowest branch node may be a gateway device (serving gateway (SGW)).

Here, in operation (e), the terminal may doubly transmit/receive the same data with the first base station and the second base station.

Here, in operation (e), the terminal may transmit/receive data different from data transmitted and received with the first base station, with the second base station.

A method for handover of a terminal simultaneously connected to a first base station and a second base station in a multi-beam environment according to another aspect of the present invention for achieving the above-mentioned object may include (a) measuring quality of a beam received from a first base station, (b) when the quality of the beam received from the first base station is equal to or less than a predetermined critical value, performing a connection release procedure with the first base station while maintaining a connection to the second base station and (c) transmitting/receiving data with the second base station.

Here, at least one of the first base station and the second base station may be a relay base station.

Here, the multi-beam environment may be operated in an SHF/EHF bandwidth. Here, in operation (b), the release of the connection to the first base station is processed at the lowest branch node to which the first base station and the second base station are both connected. At this time, when the first base station and the second base station are relay base stations connected to the same macro base station, the lowest branch node may be the macro base station, and when the first base station and the second base station are macro base stations, the lowest branch node may be a gateway device (SGW).

The present invention specifically, provides a method for handover of terminal suitable for a multi-beam management environment of SHF and EHF bandwidths.

According to the method for handover of the present invention, when a terminal moves in a network structure formed of a macro base station and many multilevel relay base stations, instead of a conventional handover procedure, by setting a multi-access and a multi-connection to many base stations, problems of latency and traffic interruption for a conventional handover signaling process may be minimized.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating an environment of a cellular communication system to which a method for handover of a terminal according to the present invention is applied;

FIG. 2 is a conceptual diagram illustrating a handover procedure of a cellular communication system;

FIG. 3 is a conceptual diagram illustrating a cellular communication system environment including relay base stations and a macro base station configuring a multi-hop;

FIG. 4 is a flowchart illustrating a first side of a method for handover of a terminal according to the present invention;

FIG. 5 is a conceptual diagram illustrating a procedure between network agents participating in a performance of a method for handover according to the present invention;

FIG. 6 is a conceptual diagram illustrating beam reception quality measurement of a terminal in a method for handover of a terminal according to the present invention;

FIG. 7 is a conceptual diagram illustrating a random access process of a terminal in a method for handover of a terminal according to the present invention;

FIG. 8 is a conceptual diagram illustrating a connection setting procedure of a terminal in a method for handover of a terminal according to the present invention;

FIG. 9 is a conceptual diagram illustrating a connection setting procedure of a base station in a method for handover of a terminal according to the present invention;

FIG. 10 is a conceptual diagram illustrating a data transmission/reception method between multi-connected base stations and a terminal in a method for handover of a terminal according to the present invention;

FIG. 11 is a flowchart illustrating another side of a method for handover of a terminal according to the present invention; and

FIG. 12 is a conceptual diagram illustrating a connection release procedure in a method for handover of a terminal according to the present invention.

### DESCRIPTION OF EXAMPLE EMBODIMENTS

The present invention may be implemented with various changes, have various example embodiments, and specific embodiments thereof are shown by way of example in the drawings and will herein be described in detail.

However, that there is no intent to limit the invention to the particular forms disclosed, but on the contrary, the invention is to cover all modifications, equivalents, and alternatives falling within the spirit and scope of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined here.

As used herein, the term “terminal” may be referred to as a mobile station (MS), user equipment (UE), user terminal (UT), wireless terminal, access terminal (AT), subscriber unit, subscriber station (SS), wireless device, wireless communication device, wireless transmit/receive unit (WTRU), moving node, mobile, or other terms. Various exemplary embodiments of a terminal may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or terminals having a combination of such functions, but are not limited to these.

As used herein, the term “base station” refers to a fixed or moving point normally communicating with a terminal, and it may be a word called base station, node-B, enode-B, base transceiver system (BTS), access point, relay and femto-cell etc.

Preferable example embodiments of the present invention will be described in detail below with reference to the accompanying drawings. In the description of the present invention, for ease of overall understanding, the same reference symbols are used with respect to the same elements in the drawings, and repetitive explanation about the same element will be omitted.

Appliance Environment of the Present Invention

Transmission of SHF/EHF bandwidths, unlike transmission using a conventional cellular bandwidth, has a constraint that a line of sight (LOS) should be ensured between transmission and reception devices when transmission is performed. This constraint indicates that a terminal should be located in an LOS area of a base station transmission beam so that the base station can communicate with the terminal

However, in the case of a downtown area or a suburban area, even with a macro base station, various obstacles such as buildings etc. may be present, and therefore it is difficult to ensure that all peripheral terminals are in the LOS area of the macro base station transmission beam.

Thus, it may be supposed that, in order to minimize a coverage hole of a base station having the LOS constraint, an environment in which various wireless repeaters relaying a signal transmitted through a base station beam are installed and used singly (single-hop) or multiply (multi-hop).

FIG. 1 is a conceptual diagram illustrating an environment of a cellular communication system to which a method for handover of a terminal according to the present invention is applied.

Referring to FIG. 1, there are a macro base station 110, a first relay base station 121, a second relay base station 122 and a third relay base station 131. As described above, when there is an obstacle 150, an LOS condition to enable a transmission beam of the macro base station to reach a terminal 140 is not satisfied, and therefore the macro base station 110 transmits/receives data with the terminal using the first, second, and third relay base stations 121, 122 and 131. At this time, the third relay base station is connected to the macro base station in a single-hop, but the second relay base station 122 is connected to the macro base station in a multi-hop through the first relay base station 121.

As a relay method of each relay base station, amplify-and-forward (AF) way or decode-and-forward (DF) etc. may be used. A relay currently being standardized by the 3rd Generation Partnership Project may manage independent cells and is assumed to include a base station of a layer 3 DF type having an additional scheduling function, almost like a macro base station, and therefore in the present invention, it will likewise be assumed that the first relay base station 121, the second relay base station 122 and the third relay base station 131 are the layer 3 DF relay base stations.

In addition, it is necessary for a terminal used in a beamforming based system to independently process a control signal and data transferred through many independent beams, through various signal processing methods, and thus in the present invention it will likewise be assumed that a terminal may independently process a control signal and data transferred from at least one and many beams in parallel.

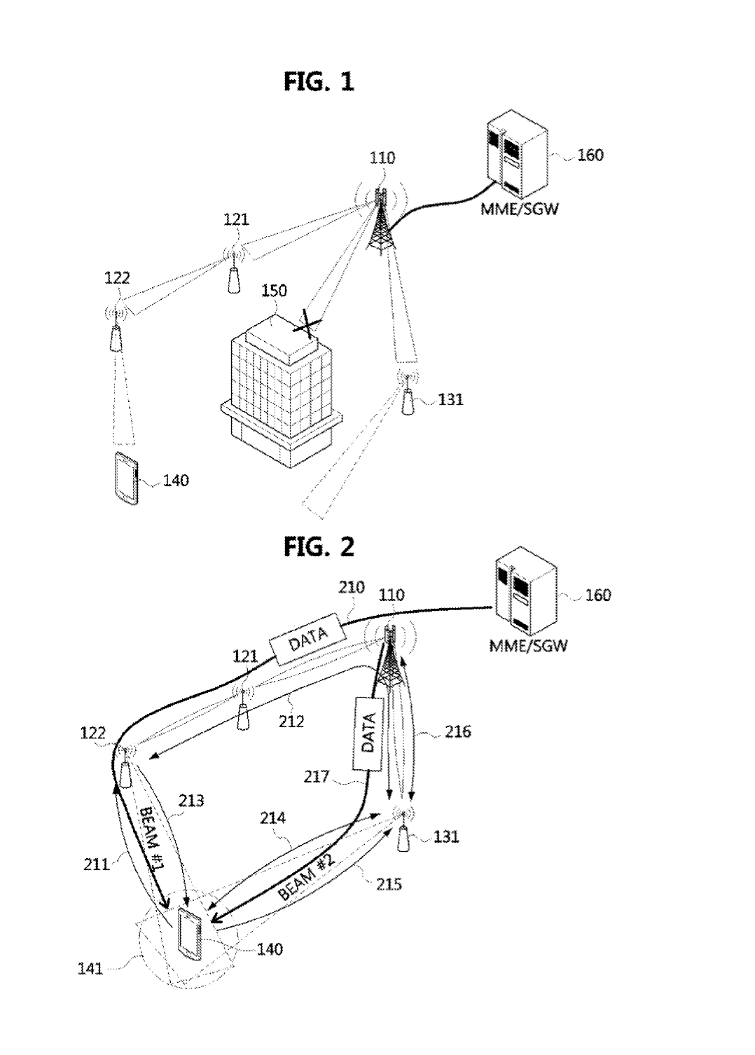

FIG. 2 is a conceptual diagram illustrating a handover procedure of a cellular communication system.

Referring to FIG. 2, when the terminal moves from an area of the second relay base station 122 to an area of the third relay base station 131, the handover procedure is performed at an area 141 in which beams of the second and third relay base stations overlap.

A normal handover procedure is as follows.

Before handover is performed, the macro base station 110 transmits/receives data with the terminal 140 through a path 210 passing through the first relay base station 121 and the second relay base station 122.

The moving terminal measures quality of the periodically received beams and continues an operation of reporting it to the base station. That is, when the terminal connected to the second relay base station 122 enters the area 141 in which the second and the third relay base stations overlap, the terminal receives both the beam from the second relay base station and the beam from the third relay base station, measures signal quality of these, and reports the result to the second relay base station (211).

The second relay base station receives the measurement result from the terminal, compares the measurement result, and transmits a handover request message to the third relay base station when the handover to the third relay base station by the terminal is needed to inform the third base station thereof, and when the third relay base station received this permits the handover of the terminal, the third relay base station transmits an approval (ACK) message to the second relay base station (212).

The second relay base station transmits the terminal a message instructing handover to the third relay base station (213). For example, in the case of a 3GPP LTE system, an RRC connection reconfiguration message may be used as the message instructing handover.

The terminal receives this, releases wireless resources for the second relay base station, and attempts to access the third relay base station (214). The attempt to access the third relay base station may include a random access procedure for the third relay base station. When a wireless connection for the third relay base station is completed, the terminal reports completion of the handover to the third relay base station (215). In order to inform of the completion of the handover, in the case of a 3GPP LTE system, an RRC connection reconfiguration message may be used.

While the third relay base station informs the macro base station of the entrance of the relevant terminal into own area, when a switching of a traffic path transmitted to the second relay base station to the third relay base station is requested, the macro base station switches the traffic path transmitted to the second relay base station to the third relay base station (216).

Then, the relevant terminal 140 transmits/receives data through the third relay base station (217).

In the conventional handover procedure above, a data amount of a signaling message and data forwarding is greater as the number of relay base stations passing from the macro base station to the terminal is greater, and thus there is problem that latency is also increased.

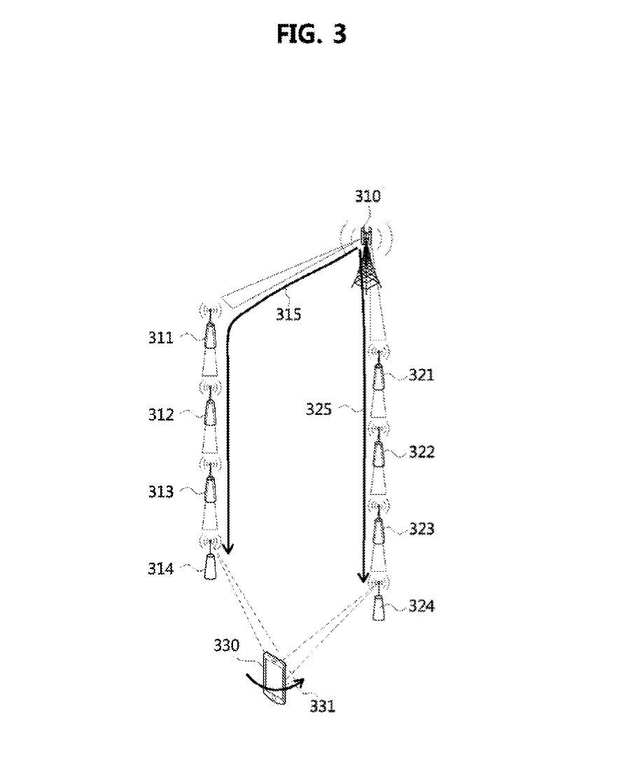

FIG. 3 is a conceptual diagram illustrating a cellular communication system environment including relay base stations and a macro base station configuring a multi-hop.

Referring to FIG. 3, a macro base station 310 uses a path passing through 4 relay base stations 311, 312, 313 and 314 for data transmission and reception with a terminal 330. After the terminal 330 moves (331 direction) and a handover is performed, the terminal 330 transmits/receives data using a path passing through the macro base station 310 and 4 relay base stations 321, 322, 323 and 324. In this case, signaling messages (handover request message, handover completion message etc.) for the handover shown in FIG. 2 are transmitted through multilevel relay, and therefore latency occurs.

Method for Handover According to the Present Invention

In the present invention, when a terminal moves between relay base stations or macro base stations in an environment (environment where multiple beams are formed and there are many relay base stations) like FIG. 1, in order to minimize signaling overhead and latency due to handover, instead of performing a conventional handover procedure (hard handover), a method for handover enabling additional connections to be performed and additional connections to a new base station to be set in order to maintain multi-connection is suggested.

The present invention is for a base station managing many beams based on beamforming technology in a cellular communication system using SHF/EHF bandwidths, and in order to overcome an LOS constraint, it is based on a network structure formed of a macro base station and many multistep relay base stations. In addition, a terminal is assumed to independently process a control signal and data transmitted from at least one and many beams in parallel.

When the terminal moves among areas of the relay or macro base station in this network structure, the conventional handover procedure may incur comparatively high signaling overhead and latency due to a multistep relay structure, and thus it may have a great effect on performance.

Thus, the present invention provides a method for handover that minimizes this effect, and the method for handover according to the present invention may be configured with two aspects.

Because multi-connection is set by additionally connecting to a new base station while maintaining a connection to an existing connected base station, the first aspect is a procedure of enabling data transmission/reception through a multi-connection with many base stations in an overlapping area

The second aspect is a procedure of releasing a connection to a base station whose area has been left while maintaining a connection to another base station upon leaving one base station area while the multi-connection is set.

The procedure of performing the multi-connection setting of the first side and the procedure of releasing a partial connection of the multi-connection are consistently conducted according to the movement of the terminal, and therefore overall handover is configured.

Hereinafter, the first aspect will be described first, and then the second aspect will be described.

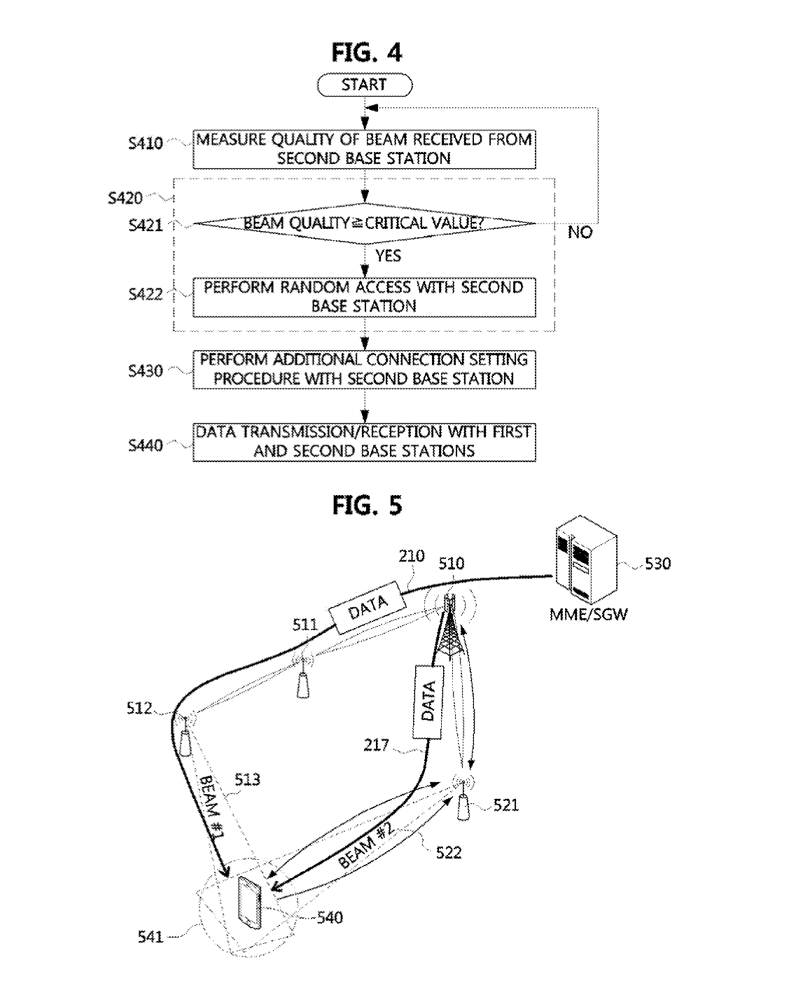

FIG. 4 is a flowchart illustrating a first aspect of a method for handover of a terminal according to the present invention. In addition, FIG. 5 is a conceptual diagram illustrating a procedure between network agents participating in performance of a method for handover according to the present invention.

Hereinafter, the method for handover according to the present invention will be described with reference to FIG. 4 and FIG. 5 together. In the following description, a first base station refers to a base station maintaining a present connection to a terminal, and a second base station refers to a base station additionally connected to the terminal. Hereinafter, the second base station may be called a ‘new’ base station. That is, the terminal is assumed to move in a direction from a beam area of the first base station to a beam area of the second base station. It should be understood that the term ‘base station’ includes both a relay base station and a macro base station. However, when a macro base station is specifically designated, the term ‘macro base station’ is used instead of ‘base station.’

The method for handover according to the present invention may be applied to a cellular communication system environment managing multiple beams in the SHF or EHF bandwidth. That is, the first base station and the second base station manage independent beams, and each of the beams may be configured to transmit/receive an independent control channel and data channel.

In FIG. 1 and FIG. 5, the first base station is expressed as second relay base stations 122 and 512, and the second base station is expressed as third relay base stations 131 and 521.

Referring to FIG. 4, the first aspect of the method for handover of terminal according to the present invention may include measuring quality of a beam received from the second base station (S410), performing random access of the second base station (S420), setting additional connection to the second base station (S430), and transmitting/receiving data with the first and second base stations (S440).

First, operation S410 is an operation for measuring the beam received from the new base station by the terminal in which the terminal measures reception quality for all received beams when the terminal enters an overlapping area in which the beams of the base stations overlap, and divides a beam of the base station to which it is presently connected and a beam of the new base station.

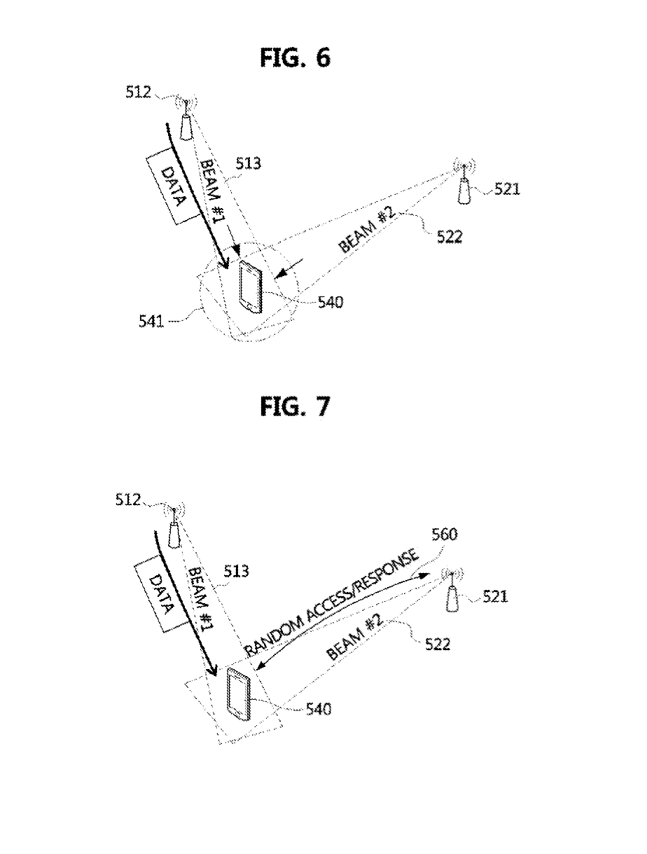

FIG. 6 is a conceptual diagram illustrating beam reception quality measurement of a terminal in a method for handover of a terminal according to the present invention. Referring to FIG. 5 and FIG. 6, a terminal 540 receives a beam 522 of a second base station 521 at an area 541 at which beams of the first base station 512 and the second base station 521 overlap, and measures beam quality of the second base station. Meanwhile, the terminal consistently receives the beam, divides base station managing the received beam and continues measuring quality of the beam, rather than beginning the beam quality measurement when the beam reaches the area where the beams overlap.

Next, in operation S420, the terminal determines whether reception quality of the beam 522 received from the new base station 521 is equal to or greater than a predetermined critical value (S421). As a result of the determination, when a signal quality of the received beam 522 is equal to or greater than the predetermined critical value, if it is determined that data transmission/reception with the new base station is possible, a random access procedure with the new base station proceeds (S422).

FIG. 7 is a conceptual diagram illustrating a random access process of a terminal in a method for handover of a terminal according to the present invention.

Referring to FIG. 5 and FIG. 7, when the terminal determines that the data transmission/reception with the second base station is possible, the terminal performs a random access procedure with the second base station.

A difference between a conventional handover method and the handover method of the present invention is that in the conventional method, the terminal reports a measurement result to the base station 512 to which the terminal is presently connected, while in the present invention, the terminal determines whether reception quality of the beam received from the new base station 521 is equal to or greater than the predetermined critical value (threshold), and when the terminal determines that the reception quality is equal to or greater than the critical value and stable data transmission/reception is possible, the terminal performs the random access procedure with the new base station 521.

For the random access procedure, the terminal transmits a random access message (for example, a random access preamble) for a wireless connection to the second base station. Thus, the new base station receives the random access message, processes random access for the relevant terminal, and transfers a response message.

Next, in operation S430, the terminal sets a connection to the new base station for data transferring. At this time, the terminal additionally sets the connection to the second base station while maintaining a connection to the first base station.

In addition, the connection of this time does not always refer to a new connection setting from the terminal to a gateway (for example: a serving gateway (SGW); 530) device of a network, but may refer to a connection to a point at which data is branched. That is, the lowest node to which the first base station and the second base station are both connected may be a branch node at which the connection procedure with the second base station is performed.

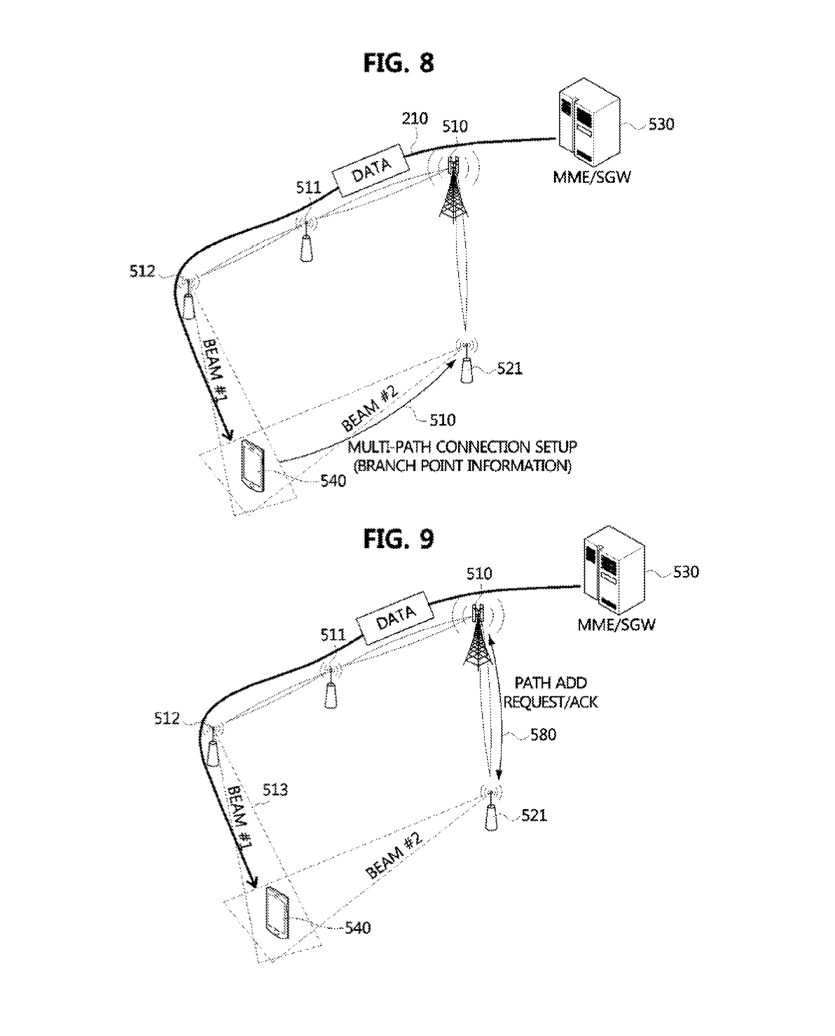

FIG. 8 is a conceptual diagram illustrating a connection setting procedure of a terminal in a method for handover of terminal according to the present invention.

Referring to FIG. 5 and FIG. 8, when the terminal 540 moves in a direction from the first base station to the second base station and the terminal sets additional connection to the second base station, a branch point is the macro base station 510. If, the terminal moves between different macro base stations, the branch point is a network device such as the gateway device (530).

At this time, the terminal attaches information to enable the base station to detect a relevant branch point, and transmits a setup message (for example, multi-path connection setup) for a multi-connection setting to the base station.

At this time, the base station (second base station) receives the setup message for the multi-connection setting transmitted from the terminal, and transmits a message for multi-connection setting to a network device such as the macro base station 510 or the gateway device 530 which is the branch point again.

FIG. 9 is a conceptual diagram illustrating a connection setting procedure of a base station in a method for handover of a terminal according to the present invention.

Referring to FIG. 9, the base station 521 detects a branch point using information received from the terminal or type information maintained in a network, and transmits a message (for example, a path add request) for the multi-connection setting to the network device such as the base station 510 or the gateway device 530 etc. which is the branch point.

Finally, operation S440 is an operation of performing data transmission/reception through multi-connected base stations by the terminal 540. That is, in operation S440, when the network device such as the base station or the gateway receives the multi-connection setting request in the previous operation S430, the network device sets a connection to the relevant base station and transmits/receives data through the multi-connection.

For the data transmission/reception, according to a performance and reliability request, (1) a method that improves performance (a data transmission rate) by separately dispersing and transmitting data to be transferred to the relevant terminal every connection and (2) a method that minimizes data loss due to terminal movement and improves transmission reliability by transmitting (for example, bi-casting) the same data through each connection may be used.

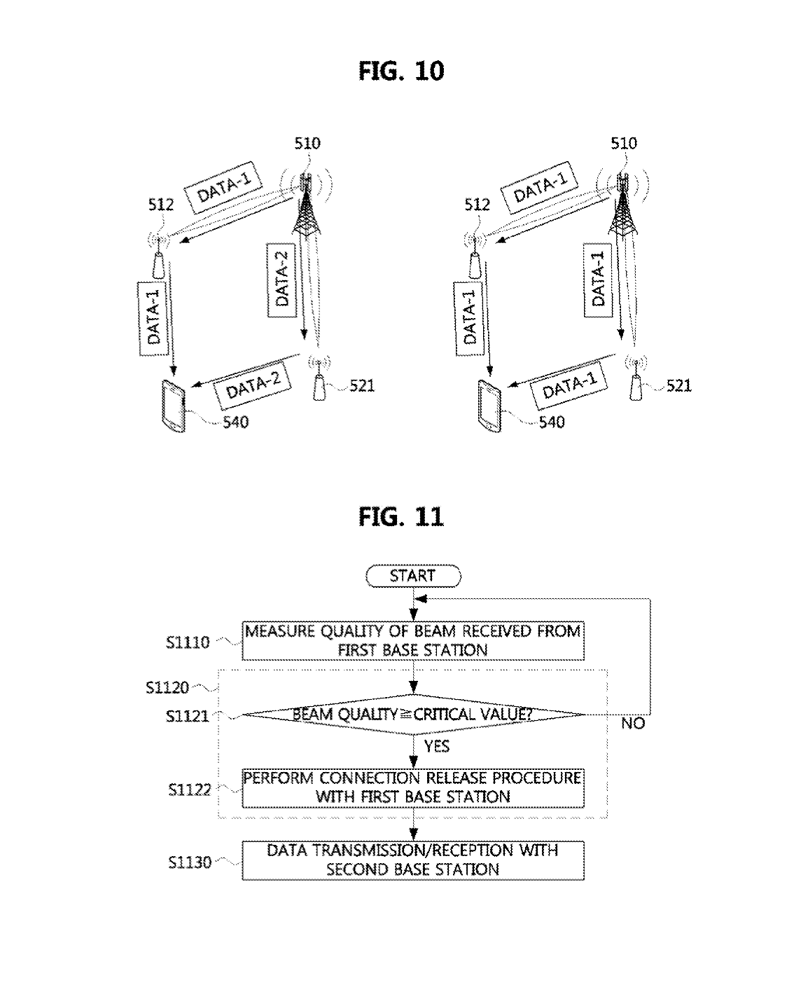

FIG. 10 is a conceptual diagram illustrating a data transmission/reception method between multi-connected base stations and a terminal in a method for handover of a terminal according to the present invention.

Referring to FIG. 10, a left situation shows a method in which the macro base station 510 transfers different data to the first base station 512 and the second base station 521 to disperse and transmit different data to the terminal, and thus increases a data transmission rate (method (1) mentioned above). In addition, a right situation shows a method in which the macro base station 510 transfers the same data to the first base station 512 and the second base station 521 to doubly transmit the same data to the terminal 540, and thus enhances transmission reliability (method (2) mentioned above).

A terminal maintaining a multi-connection to two or more base stations through the above-mentioned procedure releases a connection to a partial base station according to a distance from an existing connected base station due to movement of the terminal That is, the procedure of performing the multi-connection of the first side in the method for handover according to the present invention and the procedure of releasing partial connection among the multi-connection of the second side in the method for handover according to the present invention are consistently performed according to movement of the terminal, and therefore overall handover is configured.

Referring to FIG. 5, according to movement of the terminal in a direction away from the first base station 512 to the second base station 521 (that is, a direction 542), after maintaining a multi-connection status with the first and second base stations due to the multi-connection performance procedure, when the terminal maintains the movement toward the second base station 521, the terminal releases the connection to the first base station 512 by the partial connection release procedure and maintains only the connection to the second base station 521.

Hereinafter, a procedure of releasing a partial connection among the multi-connection which is the second aspect of the method for handover according to the present invention will be described.

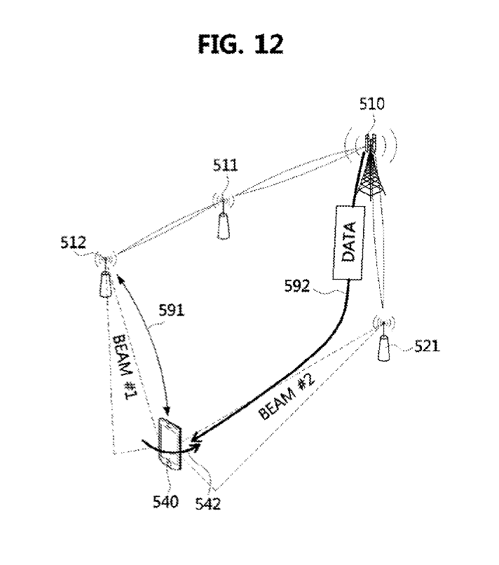

FIG. 11 is a flowchart illustrating the other aspect of the method for handover of a terminal according to the present invention. In addition, FIG. 12 is a conceptual diagram illustrating a connection release procedure in a method for handover of a terminal according to the present invention.

Referring to FIG. 11, the other aspect of the method for handover of a terminal according to the present invention may include measuring quality of a beam received from a first base station (S1110), performing a connection release procedure with the first base station while maintaining a connection to the second base station when quality of the received beam is equal to or less than a predetermined critical value (S1120), and transmitting/receiving data with the second base station (S1130).

The other aspect of the method for handover according to the present invention illustrated above will be described more in detail through FIG. 12, and in the following description, a situation in which the terminal moves in a direction from the first base station 512 to the second base station 521 will be exemplified.

Referring to FIG. 12, in operation S1110, the terminal measures quality of the beam received from the first base station. In operation S1110, like operation S410 in the first aspect of the present invention described through FIG. 4, the terminal consistently receives the beam, divides a base station managing the received beam and keeps measuring quality of the beam, rather than performing the beam quality measuring only at a specific area.

In operation S1120, the terminal determines whether a signal quality of the beam received from the first base station is decreased to a value equal to or less than a critical value (S1121), and when the signal quality is decreased to the value equal to or less than the critical value, performs a procedure of releasing the connection to the first base station (S1122). In FIG. 12, this situation refers to a situation in which signal quality is gradually degraded according to movement of the terminal toward the second base station and decrease of the signal quality to a value equal or less than a predetermined threshold.

In a conventional handover method, the terminal reports a signal quality measurement result to the first base station and the first base station determines whether or not to perform handover, while in the present invention, the terminal performs the procedure of releasing the connection to the first base station. At this time, a difference between the method for handover according to the present invention and the conventional handover method is that in the present invention the connection to the first base station is released, but the connection to the second base station is maintained without change.

At this time, the procedure of releasing the connection to the first base station may be a normal connection release procedure of an existing cellular communication system, and may be a procedure of automatically releasing a connection when a traffic transmission is discontinued for a fixed time through an RRC inactivity procedure etc.

In addition, the procedure of releasing the connection to the first base station, as described in operation S430 of the first aspect of the present invention described above, may be processed at the lowest branch node 510 to which the first base station and the second base station are both connected.

Finally, in operation S1130, the terminal performs data transmission/reception with the second base station maintaining the connection.

While the example embodiments of the present invention and their advantages have been described in detail, it should be understood that various changes, substitutions and alterations may be made herein without departing from the scope of the invention.

What is claimed is:

1. A method for handover of a terminal in a multi-beam environment, the method comprising:
(a) measuring quality of a beam received from a second base station by a terminal receiving service of a first base station;
(b) performing random access to the second base station when the quality of the beam received from the second base station is equal to or greater than a predetermined critical value;
(c) setting a connection to the second base station in addition to a connection to the first base station when the random access to the second base station is successful; and
(e) transmitting/receiving data with the first terminal and the second terminal

2. The method of claim 1,
wherein at least one of the first base station and the second base station is a relay base station.

3. The method of claim 1,
wherein the multi-beam environment is operated in a super high frequency (SHF) or extremely high frequency (EHF) bandwidth.

4. The method of claim 1,
wherein, in operation (c), the setting of the connection to the second base station is processed at the lowest branch node to which the first base station and the second base station are both connected.

5. The method of claim 4,
Wherein, when the first base station and the second base station are relay base stations connected to the same macro base station, the lowest branch node is the macro base station.

6. The method of claim 4,
wherein the lowest branch node is a gateway device (a serving gateway (SGW)), when the first base station and the second base station are macro base stations.

7. The method of claim 1,
wherein, in operation (e), the terminal doubly transmits/receives the same data with the first base station and the second base station.

8. The method of claim 1,
wherein, in operation (e), the terminal transmits/receives data different from data transmitted and received with the first base station, with the second base station.

9. A method for handover of a terminal simultaneously connected to a first base station and a second base station in a multi-beam environment, the method comprising:
(a) measuring quality of a beam received from a first base station;
(b) performing a connection release procedure with the first base station while maintaining a connection to the second base station when the quality of the beam received from the first base station is equal to or less than a predetermined critical value; and
(c) transmitting/receiving data with the second base station.

10. The method of claim 9,
wherein at least one of the first base station and the second base station is a relay base station.

11. The method of claim 9,
wherein the multi-beam environment is operated in a super high frequency (SHF) or extremely high frequency (EHF) bandwidth.

12. The method of claim 9,
wherein, in operation (b), the release of the connection to the first base station is processed at the lowest branch node to which the first base station and the second base station are both connected.

13. The method of claim 12,
Wherein, when the first base station and the second base station are relay base stations connected to the same macro base station, the lowest branch node is the macro base station.

14. The method of claim 12,
wherein the lowest branch node is a gateway device (a serving gateway (SGW)) when the first base station and the second base station are a macro base station.
